(19) United States
(12) Patent Application Publication
(10) Pub. No.: US 2009/0251330 A1
(43) Pub. Date: Oct. 8, 2009

(54) Hand-held power tool

(75) Inventors: Uwe Gerold, Lindau (DE); Joachim Keck, Eschen (DE); Norbert Welte, Klaus (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/384,371

(22) Filed: Apr. 2, 2009

(30) Foreign Application Priority Data
Apr. 3, 2008 (DE) 10 2008 000 973.3

(51) Int. Cl. G08C 19/00

(52) U.S. Cl. 340/825.69; 455/466

(57) ABSTRACT

A hand-held power tool (10) includes a housing (11), and a drive (15) arranged in the housing (10), sensors (20) for acquiring measurement data, a control unit (50) for processing measurement data and for controlling power tool functions, and a remote data transmission device (30) for wireless, network-supported digital remote data transmission and having a wireless transmitting and receiving unit and a radio antenna (32) communicating with the control unit (50).

### BACKGROUND OF THE INVENTION

1. Field of the Invention

The present invention is directed to a hand-held power tool including a housing, a drive located in the housing, sensor means for sensing operational conditions of the power tool, and a control unit for processing measurement data communicated by the sensor means and for controlling the power tool functions.

2. Description of the Prior Art

Hand-held power tools of the type mentioned above can be formed, e.g., as drive-in tools which are operated electrically or with solid, gaseous, or liquid fuels, or also with compressed air. Hand-held power tools of this kind can also be formed as rotary or at least partially percussive hand-held power tools such as, e.g., hammer drills or chisel hammers. Other examples of such power tools include drilling machines, drilling tools, demolition hammers, screw driving tools, grinding saws, circular saws, chain saws, and saber saws.

In modern hand-held power tools, it is desirable to monitor and track the power tool functions and operating conditions so that, for example, any malfunctions or operating errors, which may occur, are detected as early as possible—ideally before they happen—and countermeasures can be taken.

U.S. Pat. No. 6,123,241 discloses a hand-held power tool which is formed as a setting power tool and which has a monitoring system which lets the user know when upkeep or repairs of the power tool must be carried out. To this end, the monitoring system has a microprocessor that receives input data from different sensors. For example, the fuel pressure is monitored by a pressure sensor. Data can be downloaded from the monitoring system to an external personal computer via a corresponding interface. For this purpose, the power tool must be connected to the personal computer.

It is disadvantageous that the power tool must be located in the immediate vicinity of a personal computer in order to transfer data from the power tool to the personal computer.

### SUMMARY OF THE INVENTION

It is the object of the present invention to provide a hand-held power tool of the kind mentioned above which makes it possible to send operational data (information about power tool functions and operating conditions) and measurement data to an evaluation location in a simple manner.

This and other objects of the present invention which will become apparent hereinafter, are achieved by providing a hand-held power tool, in which there is provided a remote data transmission device for wireless, network-supported digital remote data transmission and which has a wireless transmitting and receiving unit communicating with the control unit of the power tool and has a radio antenna.

As a result of this step, data can be sent from the power tool to an evaluation location virtually from any point on earth independent from location of the power tool, without the need for the power tool to be located in the vicinity of an evaluation location of, e.g., a personal computer or the like. Communication can be bidirectional so that data can also be sent to the power tool.

In an advantageous manner, the wireless transmitting and receiving unit is formed as a GSM module. GSM modules are available as standardized components so that a remote data transmission device can be inexpensively installed in a power tool. GSM stands for Global System for Mobile Communications and is used, for example, in commercially available mobile telephones. By Global System for Mobile Communications is also meant, according to the invention, systems using the EDGE, HSCSD or UMTS standards.

Further, it is advantageous when a position determining device for global positioning is provided in addition to the remote data transmission device and communicates with the control unit. As a result of this step, the data to be sent by the remote data transmission device is supplemented by a position indicator for the current location of the power tool, which is particularly advantageous for preventing theft. Further, certain data such as, e.g., ambient temperature data, can be related to the position and geography of the area in which the power tool is used.

It is advantageous when the position determining device has a separate antenna. The separate antenna can ensure optimal reception characteristics for the reception of satellite-generated position data.

The position determining device advantageously has a GPS module which can be obtained inexpensively as a standardized component. GPS is an acronym for “Global Positioning System” as used, e.g., in commercial navigation devices.

The reception will not be affected by the power tool when the radio antenna for the GSM module and the antenna for the GPS module are arranged in a handle area of the housing. In this regard, it is also advantageous when the radio GSM antenna and the GPS antenna are arranged directly next to a wall of the housing.

It is advantageous in technical aspects when the GSM module and the GPS module are combined to form one constructional unit so that existing power tools need only be adapted slightly for outfitting with a remote data transmission device and position determining device. Constructional dimensions, power consumption and complexity can be reduced in this way.

It is further advantageous when power tool data and measurement data can be sent from the control unit to an evaluation location by the remote data transmission device by means of SMS (Short Message Service) so that a simple and reliable data transmission is ensured.

Further, it is advantageous when power tool control parameters, control programs and control program parts can be sent to the power tool electronics via the remote data transmission device by means of SMS so that the control unit can be re-programmed remotely in a simple manner. The remote data transmission device retrieves an SMS message in the wireless network after being awakened from a sleep mode.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal partially cross-sectional view of a hand-held power tool according to the present invention which is formed as a drive-in tool;

FIG. 2 a schematic view of the control unit of the hand-held power tool according to FIG. 1; and

FIG. 3 an operational diagram.

### DETAILED DESCRIPTION OF THE PREFERRED EMBODIMENT

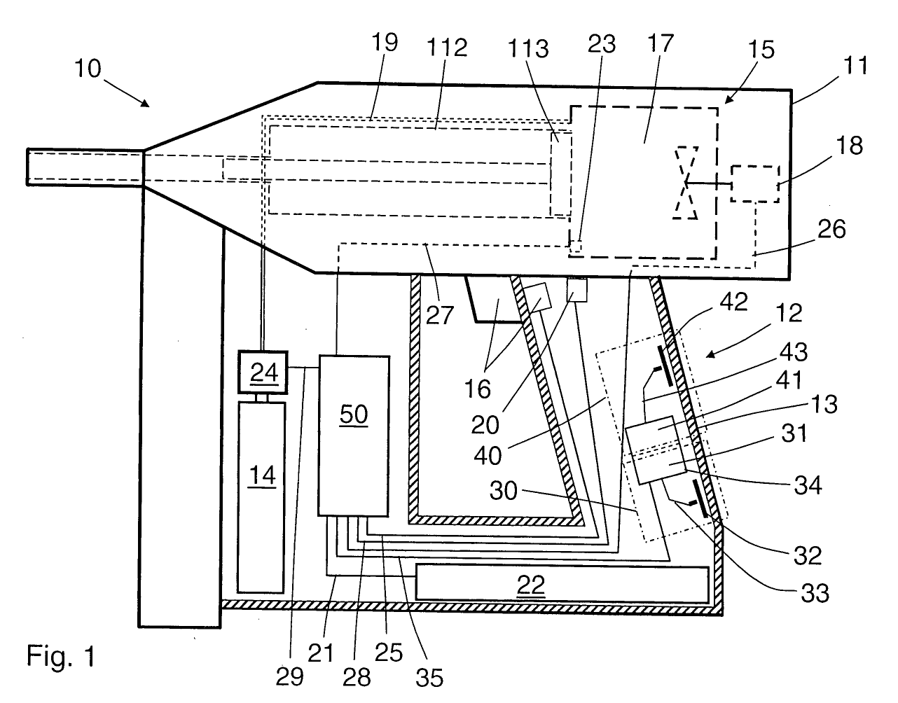

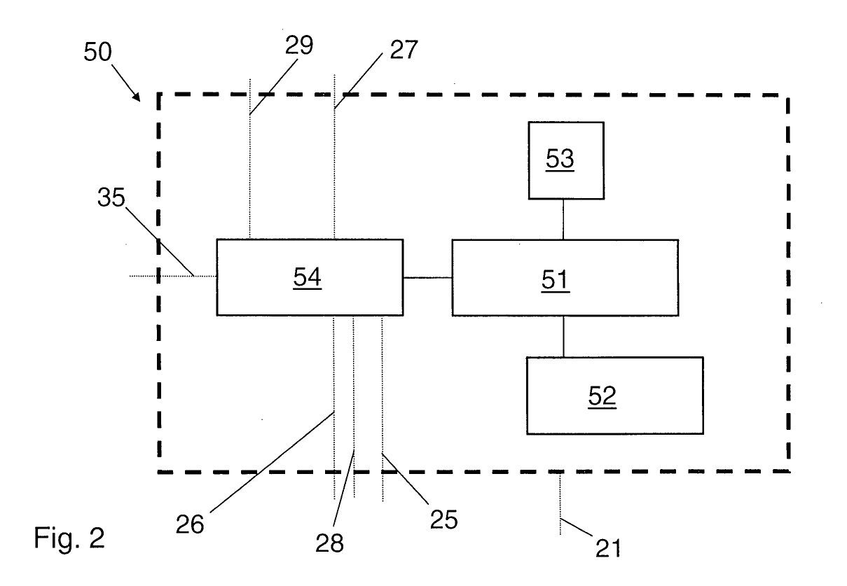

A hand-held power tool 10 according to the invention, which is shown in FIGS. 1-2, is formed as a combustion-powered setting device. The power tool 10 has a housing, designated generally by 11, which is formed of one or more parts and in which a drive 15 is arranged. A fastening element such as a nail, bolt, etc. can be driven into a workpiece by the drive 15. The fastening elements can be stored, for example, in a magazine provided at the power tool 10.

The drive includes a combustion chamber 17 and a guide cylinder 112 in which a setting piston 113 is arranged so as to be axially displaceable. As can further be seen in FIG. 1, a trigger switch 16 is arranged in a handle area 12 of the power tool 10 with which an ignition device 23, e.g., a spark plug, in the combustion chamber 17 can be triggered when the power tool 10 has been pressed against a workpiece. In addition to the trigger switch 16 mentioned above, additional switches such as, e.g., contact pressure switches, combustion chamber switches and/or magazine switches can also be provided.

The power tool 10, which is formed in the present embodiment as a setting tool, can be operated with a combustion gas or with a vaporizable liquid fuel which is provided in a fuel reservoir 14, e.g., a fuel canister, shown in FIG. 1. A fuel line 19 leads from the fuel reservoir 14 to the combustion chamber 17. A metering device 24, by which the amount of fuel needed for a respective setting process can be metered, is interposed in the fuel line 19.

A ventilator, which is arranged in the combustion chamber 17 and can be driven by a ventilator motor 18, serves to generate a turbulent flow regime of an oxidant/fuel mixture located in the closed combustion chamber 17 and to flush out the open combustion chamber 17 with fresh air after a completion of a setting process.

An electrical energy source 22 in the form of at least one battery supplies the electrical consumers of the power tool 10, e.g., the ignition device 23 and the ventilator motor 18, with electrical energy. The battery or batteries can be arranged exchangeably in the power tool 10.

Further, at least one other sensing element 20, e.g., a temperature sensor for monitoring the device temperature or ambient temperature, a pressure sensor for the fuel pressure, a pressure sensor for the atmospheric pressure, an acceleration sensor, a position sensor, a proximity sensor (e.g., for detecting the position of a fastener or tool), a Hall sensor (e.g., for measuring the speed of the setting piston), a humidity sensor, a vibration detector, a CCD receiver, or a microphone, is provided in the power tool 10. Rotation meters or torque meters, for example, could also be provided as sensing the element 20, particularly in rotating devices.

A control unit which is designated in its entirety by 50 and is shown in FIGS. 1 and 2 is provided to control and monitor the power tool functions of the power tool 10. The control unit 50 is connected to the electrical power source 22 by a first electrical line 21. Further, for the purpose of controlling and monitoring the power tool functions, the control unit 50 is connected to the trigger switch 16 by a second electrical line 25, to the ventilator motor 18 by a third electrical line 26, to the ignition device 23 by a fourth electrical line 27, to the at least one sensing element 20 by a fifth electrical line 28, to the metering device 24 by a sixth electrical line 29, and to a constructional unit by a seventh electrical line 35. This constructional unit, which includes a remote data transmission device 30 for wireless, network-supported digital remote data transmission and a position determining device 40 for global positioning, will be described in more detail below.

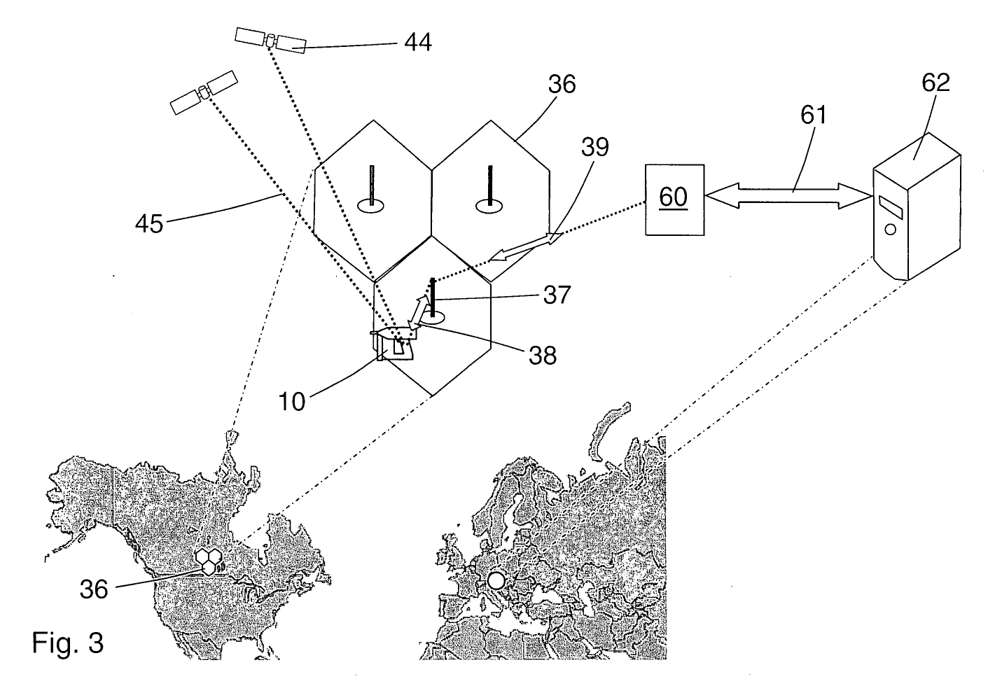

The remote data transmission device 30 has a wireless transmitting and receiving unit 31 formed, e.g., as a GSM module, and a radio antenna 32 which is connected to the latter by an eighth electrical line 33. GSM means a global System for Mobile Communications as used, e.g., in commercial mobile telephones. Measurement data and power tool data (e.g., operating condition data) of the power tool 10 can be sent to a preferably central evaluation location 62 (represented by a personal computer in FIG. 3) by the remote data transmission device 30 as it will be described in more detail below.

The position determining device 40 has a GPS module 41 and an antenna 42 connected to the latter by a ninth electrical line 43. GSM means a global positioning system such as is used in commercial navigating devices. The location of the hand-held power tool 10 can be determined by satellite by the position determining device 40 and can be sent to a evaluation location 62 when transmitting data from the power tool 10 via the remote data transmission device 30.

The GSM module 31 and the GPS module 41 are combined to form a GPS-GSM unit 34 which is arranged at a distance from the drive of the power tool 10 in a handle area 12 of the housing 11. The radio antenna 32 and the antenna 42 are arranged in the immediate vicinity of a housing wall 13 in the handle area 12 so as to ensure good reception.

The control unit 50 has at least one microprocessor 51 which communicates with a preferably nonvolatile data and program storage 52. At least one control program and power tool control parameters for the power tool 10 are stored in the data and program storage 52, and measurement data from the sensors and power tool data are stored therein during operation of the power tool 10. If necessary, the stored measurement data and power tool data can be linked to time data originating from a real-time clock 53 connected to the microprocessor 51. Further, the control unit 50 is connected by at least one interface 54 to the other electrical components and switches of the power tool 10 and to the GPS-GSM unit 34 as was already described above.

During the operation of the power tool 10, as has already been mentioned, the control unit 50 acquires power tool data (e.g., identification data, setting cadence, setting rate, time stamp, device temperature and/or ambient temperature, fill level of a fuel reservoir, charge condition of a power source (e.g., a battery), fuel metering amount, battery load voltage, battery open-circuit voltage, type of fuel reservoir, function data of a metering device, trigger and/or switch actuation, undervoltage cutoffs, error logs, malfunctions) from the power tool 10 and measurement data from the sensors 20 and, if appropriate, links these data to time data originating from the real-time clock 53. Based on a program running in the control unit, the GPS-GSM unit 34 is activated at a predefined time (e.g., daily at 0:00 hours, local time) preferably when the power tool is not in operation. The microprocessor 51 and, therefore, the control unit 50 are awakened from sleep mode by suitable triggering means (software or hardware). As can be seen from FIG. 3, the GPS module 41 then initially receives the coordinates (dotted line 45) representing the instantaneous geographical position of the power tool 10 and the UTC time (coordinated universal time) from satellite 44 via the associated antenna 42. These position data and the UTC time are conveyed from the GPS module 41 of the GPS-GSM unit 34 by line 35 to the control unit 50, where they are put together with measurement data and power tool data which are read out from the data and program storage to form a data package which is now sent to the GSM module 31 of the GPS-GSM unit 34 via line 35. These data are sent (arrow 38 in FIG. 3) from the GSM module 31, e.g., in the form of at least one SMS (Short Message Service), via the antenna 32 into the GSM network (indicated in FIG. 3 by the honeycombs 36 of the wireless network). The message is then received by at least one network antenna 37 of the GSM network and sent within the GSM network (arrow 39 in FIG. 3). The data are sent from the GSM network to the Internet (reference number 60) and are sent within the Internet to a personal computer of the evaluation location 62. Power tool control parameters, changes in the operating program, or new programs can also be sent from the evaluation location 62 to the control unit of the power tool 10 via the GSM network on a return communications path.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is calmed is:

1. A hand-held power tool (10) comprising a housing (11); a drive (15) located in the housing (11); a plurality of sensors (20) for acquiring measurement data; a control unit (50) for processing measurement data and for controlling power tool functions; and a remote data transmission device (30) for wireless, network-supported digital remote data transmission and having a wireless transmitting and receiving unit communicating with the control unit (50), and a radio antenna (32).

2. A hand-held power tool according to claim 1, wherein the wireless transmitting and receiving unit is formed as a GSM module (31).

3. A hand-held power tool according to claim 2, further comprising a position determining device (40) for global positioning that communicates with the control unit (50).

4. A hand-held power tool according to claim 3, wherein the position determining device (40) has a separate antenna (42).

5. A hand-held power tool according to claim 3, wherein the position determining device (40) comprise a GPS module (41).

6. A hand-held power tool according to claim 4, wherein the radio antenna (32) and the antenna (42) are arranged in a handle area (12) of the housing (11).

7. A hand-held power tool according to claim 6, wherein the radio antenna (32) and the antenna (42) are arranged directly next to a housing wall (13) of the housing (11).

8. A hand-held power tool according to claim 3, wherein the GSM module (31) and the GPS module (41) are combined to form one constructional unit (34).

9. A hand-held power tool according to claim 1, wherein power tool data and the measurement data can be sent from the control unit (50) to an evaluation location (62) by the remote data transmission device (30) by means of SMS.

10. A hand-held power tool according to claim 1, wherein power tool control parameters, control programs and control program parts can be sent to the control unit (50) via the remote data transmission device (30) by means of SMS.
